(19) United States
(12) Patent Application Publication
(10) Pub. No.: US 2012/0253777 A1
(43) Pub. Date: Oct. 4, 2012

(54) Method for Determining and/or Predicting the High Current Carrying Capacity of a Battery

(75) Inventor: Michael ROSCHER, Thum (DE)

(73) Assignee: Bayerische Motoren Werke Aktiengesellschaft, Muenchen (DE)

(21) Appl. No.: 13/446,529

(22) Filed: Apr. 13, 2012

Related U.S. Application Data
(63) Continuation of application No. PCT/EP2010/064824, filed on Oct. 5, 2010.

(30) Foreign Application Priority Data
Oct. 14, 2009 (DE) 10 2009 049 320.4

(51) Int. Cl. H02J 7/00

(52) U.S. Cl. 703/18

(57) ABSTRACT

A method is provided for determining and/or predicting the high current carrying capacity of a battery, wherein the parameters of a model of the battery impedance are used as a basis, and from which the high current carrying capacity of the battery is determined. Different parameters are used as the basis for the charging and discharging processes.

### CROSS-REFERENCE TO RELATED APPLICATIONS

This application is a continuation of PCT International Application No. PCT/EP2010/064824, filed Oct. 5, 2010, which claims priority under 35 U.S.C. §119 from German Patent Application No. DE 10 2009 049 320.4, filed Oct. 14, 2009, the entire disclosures of which are herein expressly incorporated by reference.

### BACKGROUND AND SUMMARY OF THE INVENTION

The invention relates to a method for determining and/or predicting the high current carrying capacity of a battery, in particular a battery of a hybrid or battery vehicle.

Predicting the behavior of an electric energy accumulator, in particular a battery, in different operating modes is very important for managing the energy of a vehicle, in particular also for safety-relevant functions. The most critical operating mode is the loading of the energy accumulator, or more specifically the battery, with a high discharging current. One example of such a high current load is the starting process of an internal combustion engine, during which the mandatory minimum speed is generated by an electric starter that is fed by an electric energy accumulator. Other applications are, in particular, the electrohydraulic braking, electric steering and electrically assisted start-up or acceleration, as used in hybrid vehicles.

If the voltage drops below a minimum voltage during this process, it is not possible to protect the energy accumulator by drawing an adequate amount of power from the energy accumulator, or more specifically the battery, so that the process can be successfully terminated.

A wide range of strategies for determining or predicting the power output capacity of a battery of a motor vehicle are known from the prior art. In order to determine the maximum current carrying capacity, there exist methods for determining a resistance from the short term high current loads on the battery. This resistance is a measure for the voltage dip of the battery during this loading.

In addition, there exist strategies, wherein a battery impedance can be derived from the alternating component of current and voltage without active excitation (for example, DE 10337064 B4, GB 2352820 A, WO 2005050810 A1 and U.S. Pat. No. 6,037,777). The result is an average battery impedance for the entire current range.

If the battery impedance is determined for an average current range, then the prognosis for high currents—for example, for a maximum power output prognosis—is too conservative. That is, it yields a value for the maximum power output that is clearly too small. If, on the other hand, the impedance is determined from the high current pulses, then the results are inaccuracies for the midrange and small currents. The latter leads to considerable inaccuracies with respect to the maximum current carrying capacity, especially in the case of model-based state determining methods.

The object of the present invention is to provide a method that is easy to implement and is intended for determining and/or predicting the high current carrying capacity of a battery with a high degree of accuracy.

The invention achieves this and other objects by providing a method for determining and/or predicting the high current carrying capacity of a battery. The parameters of a model of the battery impedance are used as a basis, and from these parameters the high current carrying capacity of the battery is determined. In so doing, different parameters are used as the basis for the charging and discharging processes, and these different parameters in turn are derived from different characteristic lines. The term different means, as shown below in detail, that in the event of a reflection symmetry with regard to the (current =) 0 line, the characteristic line that is decisive for the charging process—that is, a positive current direction—does not agree with the characteristic line that is decisive for the discharging process—that is, the negative current direction.

Advantageous further developments of the invention are described and claimed herein.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows an alternative circuit diagram of an electric energy accumulator;

FIG. 2 is a graphical diagram for the purpose of explaining the physical basis of the invention;

FIG. 3 is a circuit diagram for the purpose of explaining the method according to the invention; and

FIG. 4 is a graphical diagram for the purpose of explaining a detail in the circuit diagram from FIG. 3.

### DETAILED DESCRIPTION OF THE DRAWINGS

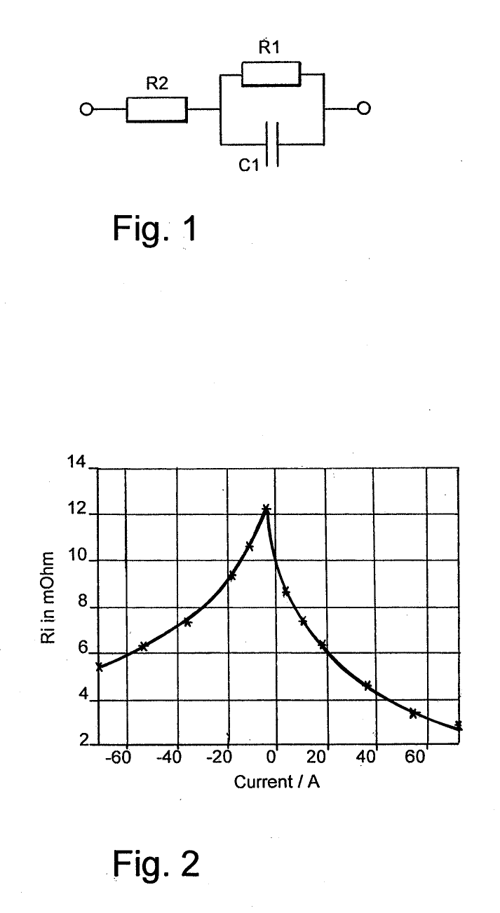

The alternative circuit diagram (hereinafter referred to as ESB) shown in FIG. 1 makes it possible to describe the dynamic behavior of a battery. The ESB comprises a series resistor R2 and, in series therewith, an RC [resistance capacitance] element (R1, C1). As a result, it is possible to map the transient processes.

The behavior of the depicted ESB can be simulated with a discrete transfer function (G(z)) in the time domain. With this transfer function it is possible to calculate the initial value of the model as a linear combination of the current (currently and aged by a time step) and the aged voltage in a way that is known from the prior art.

In the case of batteries the R2, R1 and C1 parameters of the ESB are current-dependent. Consequently, the coefficients of the discrete transfer function of the ESB are also current-dependent. In total the result is a relationship between the real component of the battery impedance Ri (in ohms) and the current, as shown in FIG. 2, that is influenced by the current direction and the current intensity.

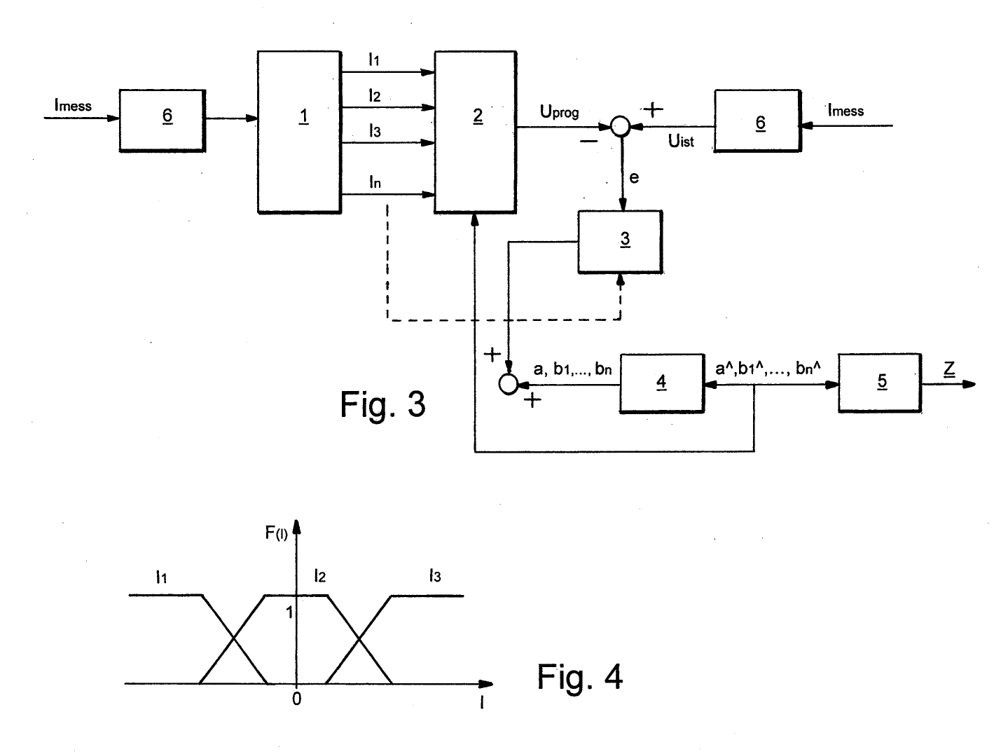

According to the invention, the current-dependent impedance parameters are calculated as shown in FIG. 3. The voltage Umess and current Imess of the battery are derived from the measurement data by means of a digital high pass filter (6) that determines the alternating component of the current and voltage. The current is split according to its amplitude in a current splitter (1); one obtains the current components I1, . . . , In for the respective current ranges (the calculating blocks shall be described in detail below). Through linear combination in a combiner (2), a voltage response Uprog of the battery is predicted from the current components I1, . . . , In and the coefficients to be adapted a, b1, . . . bn of the discrete transfer function, stored in the coefficient storage (4). From this voltage response of the battery and the high pass filtered actual battery voltage Uᵢₛₜ, the difference e is formed. From this difference and the current components the change in the coefficients a, b1, . . . bn is calculated by way of a correction term in an adapter (3), and from the sum of the old coefficient and its change the new coefficients â, b1̂, . . . bn̂ of the transfer function are calculated. The new coefficients â, b1̂, . . . bn̂ are stored in the coefficient storage (4) and used in the next calculating step. From the coefficients â, b1̂, . . . bn̂ the impedance parameters are calculated selectively for the current ranges by use of a distinct transformation in a converter (5).

In the current splitter (1) the high pass filtered current is assigned to a specific current range as a function of the sign and/or the amplitude of the current. FIG. 4 shows an example of this splitting function F(I) for three current ranges. According to the invention, the current ranges mutually overlap, that is, one current can be split into two or more ranges (as shown in FIG. 4) or be sharply delimited from each other. In order to obtain the current components I1, . . . , In, assigned to the ranges, the current is multiplied by the splitting functions F(I) of the current ranges.

The current components I1, . . . , In are multiplied by the coefficients a, b1, . . . bn of the transfer function at each sampling instance k in the combiner (2) (equation 1, running variable n corresponds to the subscript of the current range).

U_{prog, k}=a·U_{prog, k-1}+b_{1, 0}·I_{1, k-1}+ . . . +b_{n, 0}·I_{n, k}+b_{n, 1}·I_{n, k-1} (Equation 1)

In this way the battery is modeled as a MISO system (multi-in (I1, . . . , In), single-out (Uprog)). Hence, two coefficients bn, 0, bn, 1 of the transfer function correspond to each current range n. The coefficient a represents the feedback voltage and is, therefore, independent of the current range owing to the overlapping of a plurality of R-RC elements.

With respect to components (3) and (4): the calculation of a correction of the coefficients of the transfer function in the adapter (3) and a delay of the coefficients by a time step in the storage (4) are known, for example, as “recursive least squares.”

In the converter (5) the real battery impedance parameters are assigned to the individual coefficients â, b1̂, . . . bn̂, as a function of the respective current ranges (belonging to the current range n), according to the following equations 2 to 4 (the series resistor for the current range n corresponds to R_{n, 2}; the parallel resistor corresponds to R_{n, 1}; and the capacitor corresponds to C_{n, 1}).

R_{n, 2}=b_{n, 0} (Equation 2)

R_{n, 1}=T/[b_{n, 0}−a·b_{n, 0}] (Equation 3)

C_{n, 1}=[b_{n, 1}−b_{n, 0}]/[a+1] (Equation 4)

The invention makes it possible to achieve a reliable determination of the battery impedance under all operating conditions.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for at least one of determining and predicting a high current carrying capacity of a battery, the method comprising the acts of:
basing the determining and/or predicting of the high current carrying capacity of the battery upon parameters of a model of an impedance of the battery; and
using different parameters as a basis for charging and discharging processes.

2. The method according to claim 1, wherein different characteristic lines are assigned to the parameters of the model of the battery impedance for the charging and the discharging processes.

3. The method according to claim 1, further comprising the acts of:
assigning three parameter ranges for an entire current intensity range; and
wherein the three parameter ranges are assigned to the charging process, a neutral state, and the discharging process.

4. The method according to claim 2, further comprising the acts of:
assigning three parameter ranges for an entire current intensity range; and
wherein the three parameter ranges are assigned to the charging process, a neutral state, and the discharging process.

5. The method according to claim 1, further comprising the acts of:
assigning more than three parameter ranges for an entire current intensity range; and
wherein boundaries of the more than three parameter ranges are defined by values of a respective current intensity.

6. The method according to claim 2, further comprising the acts of:
assigning more than three parameter ranges for an entire current intensity range; and
wherein boundaries of the more than three parameter ranges are defined by values of a respective current intensity.

7. The method according to claim 3, wherein the three parameter ranges overlap.

8. The method according to claim 4, wherein the three parameter ranges overlap.

9. The method according to claim 5, wherein the more than three parameter ranges overlap.

10. The method according to claim 6, wherein the more than three parameter ranges overlap.

11. The method according to claim 3, wherein the three parameter ranges do not overlap.

12. The method according to claim 4, wherein the three parameter ranges do not overlap.

13. The method according to claim 5, wherein the more than three parameter ranges do not overlap.

14. The method according to claim 6, wherein the more than three parameter ranges do not overlap.
